(19) United States
(12) Patent Application Publication
(10) Pub. No.: US 2005/0130106 A1
(43) Pub. Date: Jun. 16, 2005

(54) Mathematical training abacus system

(76) Inventor: Tenny Sik-Keun Ho, Toronto (CA)

Correspondence Address: DAVID W. WONG, 46 WILLOWBROOK ROAD, THORNHILL, ON, L3T 4W9, CA

(21) Appl. No.: 10/737,132

(22) Filed: Dec. 16, 2003

(51) Int. Cl. G09B 5/00

(52) U.S. Cl. 434/201

(57) ABSTRACT

A mathematical training system includes an electronic abacus device. The sequence of operating counter beads of the abacus is converted to data signal by sensors. The data signals are outputted to a computer device having a monitor display for showing the operation of an instructor's abacus as well as a student's abacus. The student's operation is recorded such that it may be reviewed in any selected time by the instructor to assess whether the student has operated the abacus correctly to arrive at the solution of a mathematical assignment. The computer may also provide a warning and a corrective operation to the student when an erroneous manipulation is detected.

### FIELD OF THE INVENTION

This invention relates to a system and method of mathematical training with abacus, and more particularly relates to a mathematical training system in which an instructor may monitor selectively, in either real time or in a chosen time, the approach of solving a mathematical problem by a student and/or a plurality of students so as to assure the correctness of the approach in solving the problem by a selected student.

### BACKGROUND OF THE INVENTION

Solving of mathematical problems is an excellent way of training the mind for improving a person's analytical, logical and comprehension skills. Abacus is a useful device for solving mathematical problems and it is particularly conducive for mind training. When abacus is operated in a correct manner, it can be used for solving even complex mathematical problems quickly and accurately, and with such training and practice, the mind may be trained to such degree that it is capable eventually of solving mathematical problems mentally and quickly even without the use of the abacus. Such training will enhance not only a person's basic learning skills, but more importantly it will increase the person's level of concentration and confidence, as well as boosting the brain power in solving other tasks, and problems.

In order to train a student in operating an abacus correctly, it has been necessary for an instructor to observe closely the student in an individual, one-on-one, basis in operating the abacus in order to ensure that the solution is arrived at with a correct approach and manipulation of the counter beads of the abacus rather than by coincidence. For this reason, it is not satisfactory for an instructor to allot an assignment to a student and thereby merely judging the student's skill by looking at the correctness of the answer. This task is therefore time consuming for the instructor to carry out, and it becomes even more difficult to carry out when a plurality of students are being trained, since it would require the same number of instructors as the number of students, and each instructor must spend time in training the particular student by accompanying that student and observing the operation of the abacus and the approach used by the student while an assignment is being solved. It has been found that a student tends to repeat the same error in operating the abacus if the error is not corrected immediately, and the error would be compounded so that the student would becomes illogical rather than logical. An experienced instructor is also necessary to detect a student's error while observing the latter in the operation of the abacus, and it requires time and high cost for training such instructor. Thus, the training process of a student is extremely time consuming and costly.

### SUMMARY OF THE INVENTION

It is a principal object of the present invention to provide a system having an electronic abacus device which transforms the operation of the abacus into digital data signals that may be processed by a data processing device and the entire operation may be displayed on a display monitor so that a student may initially follow the an instructor's operation of the abacus in learning how to solve a mathematical problem.

It is another object of the present invention to provide a system which can monitor the student's operation of the abacus and can indicate a corrective action to the student immediately when an error is detected.

It is another object of the present invention to provide a system in which a data processing device records the operation of the abacus by a student in solving a mathematical assignment such that every step of the entire operation may be subsequently reviewed by an instructor to determine if the correct approach has been followed to arrive at the correct solution of the assignment.

It is yet another object of the present invention to provide a system which is capable of creating mathematical assignments for training the student to overcome the tendency of repeating an incorrect manipulation of the abacus.

It is still another object of the present invention to provide a system which facilitates the training of a plurality of students by a single instructor.

### BRIEF DESCRIPTION OF THE DRAWINGS

Other objects and advantages of the present invention will become apparent from the following detailed description of the preferred embodiments thereof in connection with the accompanying drawings, in which

FIG. 1 is a perspective partial top elevation view of the electronic abacus device of the present invention with portions therein removed to show the electrical components located below the abacus.

FIG. 2 is a sectional side elevation view of the electronic abacus device along cross sectional II-II of FIG. 1.

FIG. 3 is a top perspective elevation view of the electronic components board mounted below the abacus.

FIG. 4 is an enlarged isolated side elevation view of the sensor mounted on the electronic components board.

FIG. 5 is an enlarged isolated side view of a single counter bead and the associated sensor.

FIG. 6 is a computer monitor display of the operation of the training system according to the present invention.

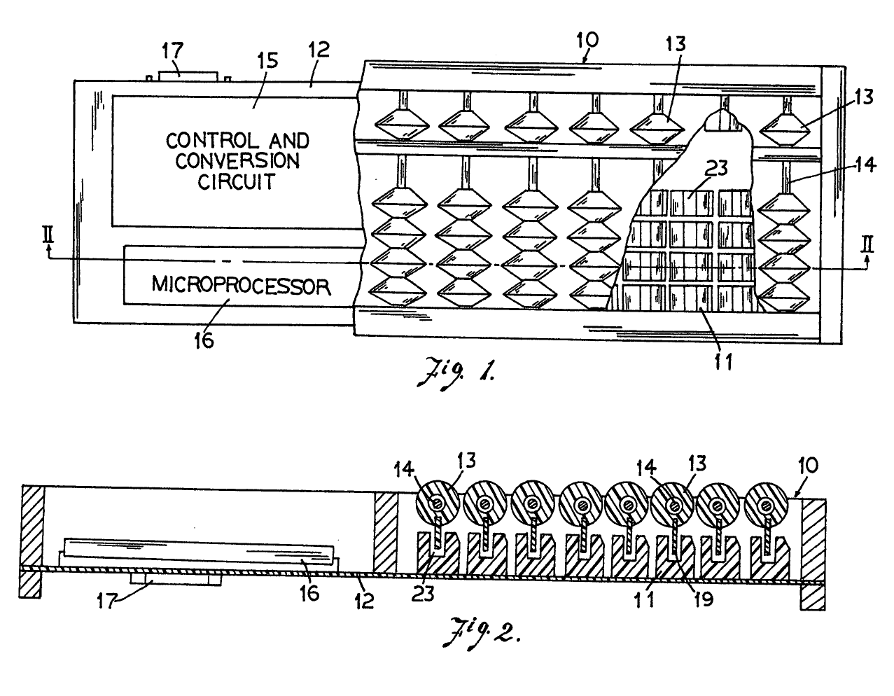

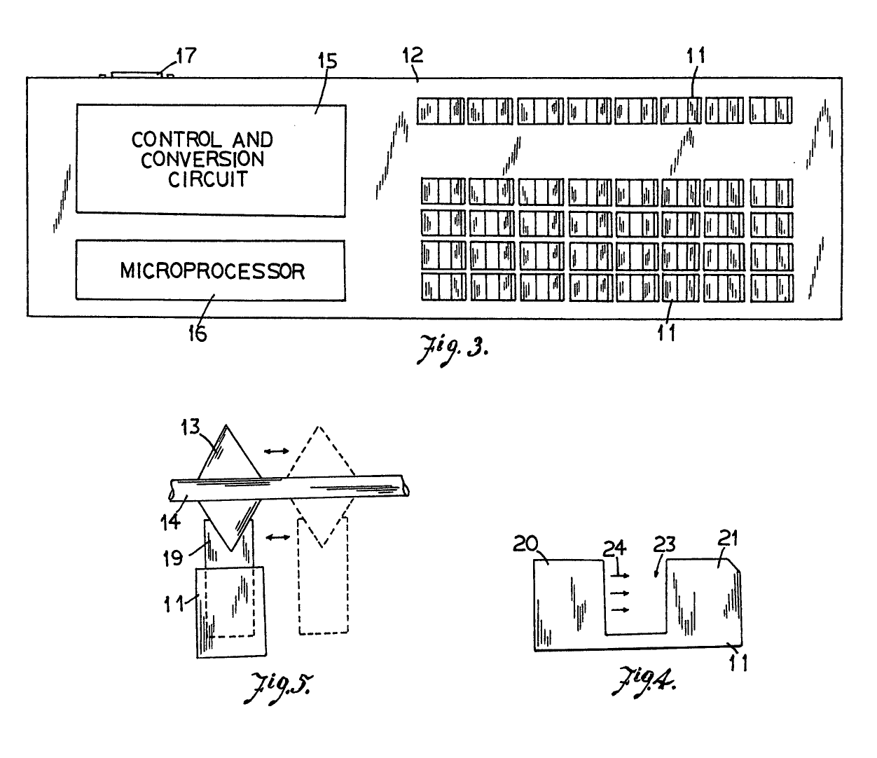

### DETAILED DESCRIPTION OF THE PREFERRED EMBODIMENTS

With reference to the drawings, in which like reference numerals designate the same component parts in the various views, the system of the present invention includes an abacus 10 mounted above a plurality of motion sensors 11. The sensors may be mounted on a circuit board 12 located directly below the counter beads 13 of the abacus 10. The counter beads 13 are slidable up or down guide bars 14 for mathematical calculation operations. Each sensor 11 detects the sliding up and down movements of the associated counter piece 13 directly located above it during the use of the abacus 10 for solving a mathematical problem. The sensors 11 provides electrical signals which are forwarded to a control and conversion circuit 15 and a microprocessor 16 which in combination therewith convert the electrical signals to information digital data signals indicative of the sequential movements of the counter beads 13. The information digital data signals are outputted to a data processing device such as a computer through an output port 17. The computer operating under an operating software program displays the manipulation of the counter beads 13 in a monitor display 18 as best shown in FIG. 6. The display 18 may show both the pictorial representations of the instructor's abacus as well as the student's abacus such that initially a student may operate the counter beads of the training abacus by following the instructor's manipulation in solving a mathematical problem, or it may only show the pictorial representation of the student's abacus when the student is exercising independently in solving an assigned problem. It is essential that the counter beads 13 of the abacus 10 are operated in a correct manner or sequence in order for the student to become proficient in using the abacus. The operation of the abacus separately by each individual student in solving a mathematical problem is both monitored and recorded in the individual computer. The operating program of the computer is capable of issuing a warning to the student whenever an erroneous manipulation of the counter beads is detected such that the student may correct the error immediately. This would eliminate the tendency of the student in repeating the same kind of erroneous operation which often cause the student to become illogical rather than logical. Furthermore, the instructor may review subsequently the operation of the abacus by each student from the computer recorded data to judge whether the student has followed or employed the correct operation for arriving at the solution of the mathematical problem.

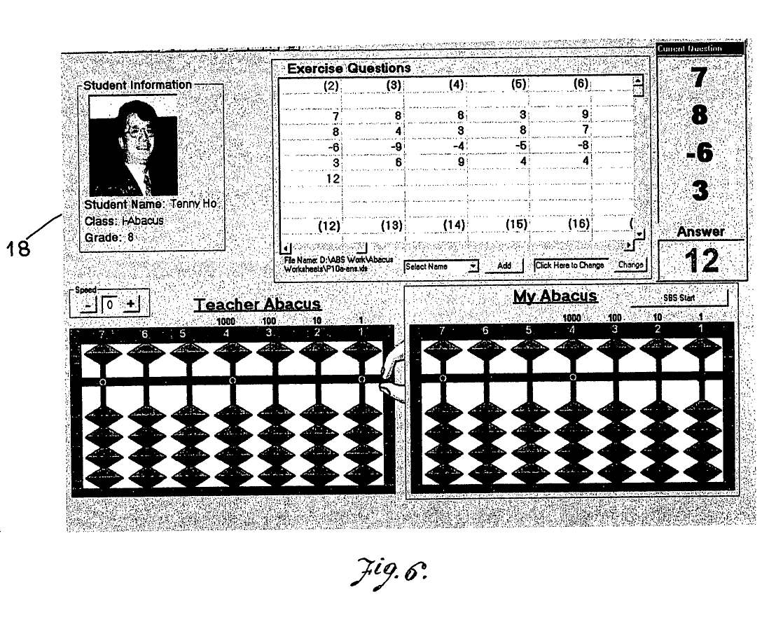

In the exemplary embodiment, the electronic abacus of the present invention has a vertical baffle panel 19 mounted at the underside of each counter bead 13 and extending downwardly therefrom. As best shown in FIG. 4, the sensors 11 are light sensors having a light emitting portion 20 and a light receiving portion 21 separated by a gap 22. In operation, the light 23 emitted from the light emitting portion 20 impinges on the receiving portion 21 across the gap 23. The baffle panel 19 of each counter bead 13 extends in a spaced manner in the gap 23 of each associated sensor 11 across the light path between the light emitting portion 20 and the light receiving portion 21 of the sensor 11. When the counter bead 13 is operated during calculation, the baffle panel 19 would slide in and out of the gap 23, as shown by the arrows in FIG. 5, to interrupt the light path of the light 24 intermittently. The intermittent light signals in the receiving portion 21 produces a series of digital signals representing the operation sequence of the counter bead 13. These digital signals are converted by the combination of the control and conversion circuit 15 and microprocessor 16 to digital data signals which may be processed by a data processing device such as a computer system. The digital data signals are outputted to the computer system through the output port 17. The operation of the counter beads of the abacus is displayed pictorially on the monitor screen of the computer system operated with an operation software program such that operation of the counter beads by the instructor and the student may be visually viewed by the student and the instructor. The digital data signals are also recorded by the computer system such that the instructor may subsequently review recorded digital data signals at any selected time the entire operation of the abacus by the student, step by step, so as to assess the correctness of the operation employed by the student in solving an assigned mathematical problem. Furthermore, the computer system operated by the software program is capable of generating corrective exercises for the student to practice so as to eliminate the tendency of making the same error by the student in operating the abacus.

It can be appreciated by those skilled in the art that other motion sensing device other than the light sensor as shown in the above exemplary embodiment may be employed in association with the control and conversion circuit for converting the sequential movement of the abacus counter beads to the digital data signals that may be processed by the computer system. For example, the movement of the counter beads may be sensed by a video camera which provides video signals for the control and conversion circuit to convert to the digital data signals for the operating the application program of the monitoring computer system. Also, magnetic means may be provided in combination with the counter beads of the abacus for providing electrical signals to the control and conversion circuit for establishing the digital data signals to operate the monitoring computer system.

Various modifications can be made without departing from the spirit of this invention or the scope of the appended claims. The embodiments set forth in this disclosure are given as examples and are in no way final or binding. In view of the above, it will be seen that several objects of the invention are achieved and other advantages are obtained. As many changes could be made in the above construction and methods without departing from the scope of the invention, it is intended that all matter contained in the above description shall be interpreted as illustrative and not in a limiting sense.

1. A mathematical training system having an electronic abacus device comprising,
an abacus having plurality of counter beads slidably mounted on guide bars and operative slidably with up and down movements on said guide bars for carrying out mathematical calculations,
motion sensor located below said abacus and operative for detecting movements of said counter beads and generating a series of electrical signals representing sequence of said up and down movements,
electrical control and conversion circuit means connected to said motion sensor and operative by said electrical signals and in combination with a microprocessor for converting said electrical signals to digital data signals.

2. A mathematical training system having an electronic abacus device comprising,
an abacus having a plurality of counter beads slidably mounted on guide bars and operative for carrying out mathematical calculations,
a plurality of motion sensors mounted on a components board located below said abacus,
baffle members mounted on said counter beads and extending downwards therefrom to said sensors, and operative to interact with said sensor to generate a series of electrical signals representing up and down sliding motions sequences of said counter beads along said guide bars,
electrical control and conversion circuit means adapted at said components board and operative in association with a microprocessor for converting said electrical signals to digital data signals.

3. A mathematical training system according to claim 2 including a computing device having a display monitor adapted to receive and process said digital data signals for displaying a pictorial representation on said display monitor of said abacus and movements of said counter beads during operation of said abacus for mathematical calculation.

4. A mathematical training system according to claim 3 wherein said sensors include a light emitting portion and a light receiving portion situated opposite to one another with an air gap located therebetween, and said baffle members are baffle panels mounted on said counter beads and extending from each counter bead to said air gap of an associated sensor located directly below said each counter bead.

5. A mathematical training system according to claim 4 wherein said baffle panels is normally located in said air gap of each sensor for blocking the light from said emitting portion of said sensor from impinging on said light receiving portion, and said baffle panels sequentially blocking and unblocking said light when said counter beads are operated slidably up and down said guide bars during the mathematical calculation whereby said electrical signals are generated by said sensors.

6. A mathematical training system according to claim 5 including an output port located on said components board and adapted for electrical connection with said computing device for transferring said digital data signals to said computing device for displaying a pictorial representation of the operation of the abacus in a monitor display.

7. A mathematical training system according to claim 6 including recording means adapted for recording said digital data signals whereby the operation of the abacus by a student for solving an mathematical assignment is retrievable by an instructor to review the operation of the abacus step by step by the student for solving the mathematical assignment.

8. A mathematical training system according to claim 6 wherein said monitor display shows pictorial representation of both the operation of the instructor's abacus and the operation the student's abacus.
